(19) United States
(12) Patent Application Publication
(10) Pub. No.: US 2022/0323984 A1
(43) Pub. Date: Oct. 13, 2022

(54) Sprinkler Clamp Assembly

(71) Applicant: Fred C. Aviguetero, JR., Koloa, HI (US)

(72) Inventor: Fred C. Aviguetero, JR., Koloa, HI (US)

(21) Appl. No.: 17/225,293

(22) Filed: Apr. 8, 2021

(51) Int. Cl. B05B 15/62; B05B 15/656; B25B 5/14; B25B 5/04

(52) U.S. Cl. CPC B05B 15/62; B05B 15/656; B25B 5/147; B25B 5/04

(57) ABSTRACT

A sprinkler clamp assembly for servicing sprinkler heads includes a clamp that has a pair of curved jaws. Each of the curved jaws curves toward each other such that the pair of curved jaws defines a circle when the clamp is biased into a closed position. In this way the curved jaws can encircle a stem of a sprinkler head. Each of the curved jaws rests against a housing of the sprinkler head when the curved jaws are positioned around the stem of the sprinkler head. A head of the sprinkler head abuts each of the curved jaws when the stem retracts into the housing to retain the head in an exposed position for servicing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to clamp devices and more particularly pertains to a new clamp device for servicing sprinkler heads. The device includes a pair of curved jaws that form a circle when the curved jaws are in a closed position. In this way the curved jaws can conform to a stem of a sprinkler head. Additionally, the curved jaws inhibit the stem from being retracted when the sprinkler head is turned on to facilitate servicing the sprinkler head.

### (2) Description of Related Art Including Information Disclosed Under 37 CFR 1.97 and 1.98

The prior art relates to clamp devices including a variety of sprinkler removal tools for servicing sprinkler heads. Additionally, the prior art discloses a variety of installation tools for installing a sprinkler head onto an underground sprinkler line.

### BRIEF SUMMARY OF THE INVENTION

An embodiment of the disclosure meets the needs presented above by generally comprising a clamp that has a pair of curved jaws. Each of the curved jaws curves toward each other such that the pair of curved jaws defines a circle when the clamp is biased into a closed position. In this way the curved jaws can encircle a stem of a sprinkler head. Each of the curved jaws rests against a housing of the sprinkler head when the curved jaws are positioned around the stem of the sprinkler head. A head of the sprinkler head abuts each of the curved jaws when the stem retracts into the housing to retain the head in an exposed position for servicing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a sprinkler clamp assembly according to an embodiment of the disclosure.

FIG. 2 is a back perspective view of an embodiment of the disclosure.

FIG. 3 is a top phantom view of an embodiment of the disclosure.

FIG. 4 is a back view of an embodiment of the disclosure.

FIG. 5 is a perspective in-use view of an embodiment of the disclosure.

FIG. 6 is a perspective in-use view of an embodiment of the disclosure showing a head of a sprinkler head being exposed.

### DETAILED DESCRIPTION OF THE INVENTION

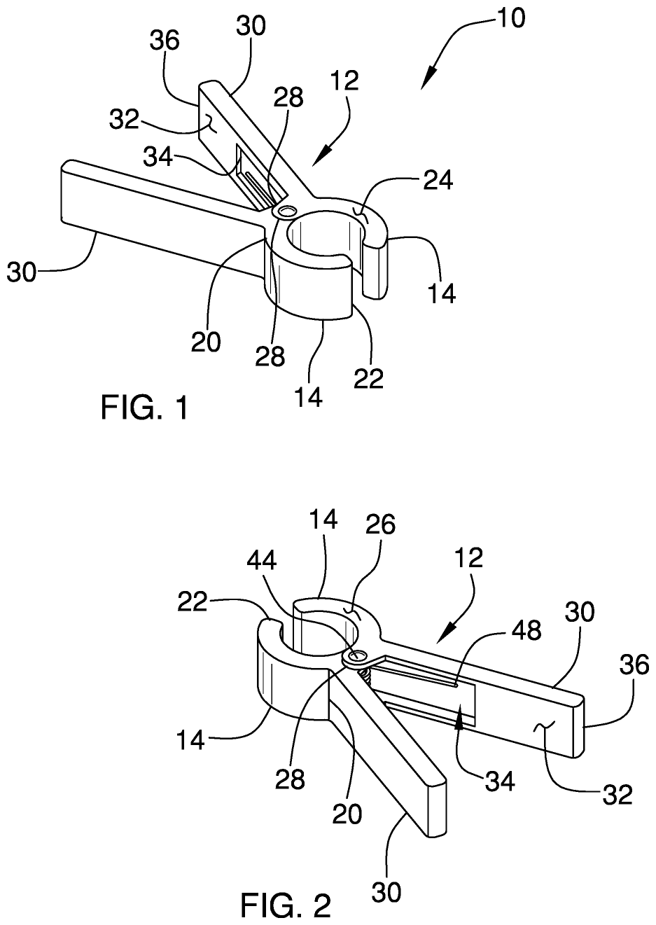

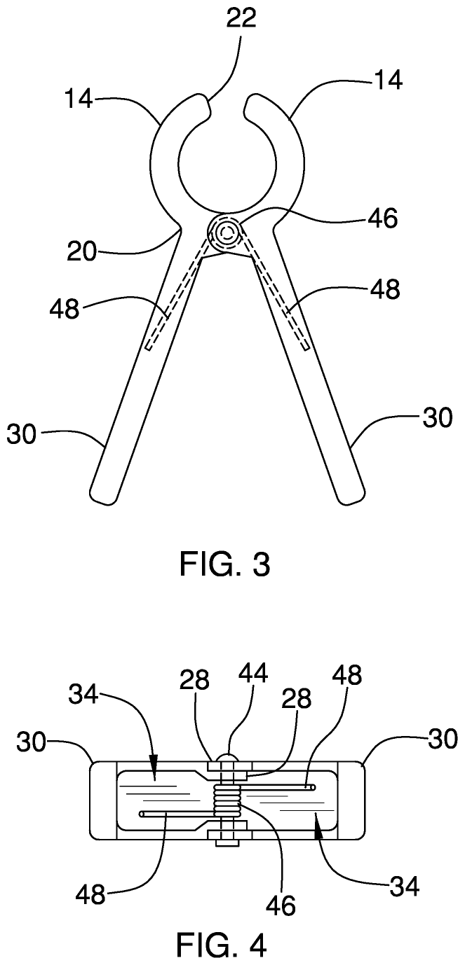

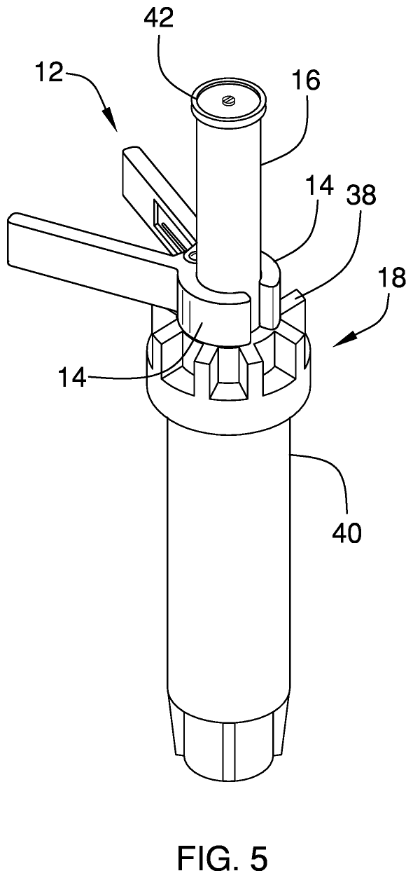

With reference now to the drawings, and in particular to FIGS. 1 through 6 thereof, a new clamp device embodying the principles and concepts of an embodiment of the disclosure and generally designated by the reference numeral 10 will be described.

As best illustrated in FIGS. 1 through 6, the sprinkler clamp assembly 10 generally comprises a clamp 12 that has a pair of curved jaws 14. Each of the curved jaws 14 curve toward each other such that the pair of curved jaws 14 defines a circle when the clamp 12 is biased into a closed position. In this way the curved jaws 14 can encircle a stem 16 of a sprinkler head 18. The circle defined by the curved jaws 14 may have a diameter of approximately 0.625 inches. Additionally, the sprinkler head 18 may be a rotary sprinkler head that extends when the sprinkler head 18 is turned on and retracts when the sprinkler head 18 is turned off.

Each of the curved jaws 14 has a rear end 20 and a front end 22, and each of the curved jaws 14 is concavely arcuate between the front end 22 and the rear end 20. Each of the curved jaws 14 has a top surface 24 extending between the front end 22 and the rear end 20, and each of the curved jaws 14 has a bottom surface 26 extending between the front end 22 and the rear end 20. The front end 22 of each of the curved jaws 14 is spaced apart from each other when the clamp 12 is in the closed position.

Each of the curved jaws 14 includes a lobe 28 that extends laterally away from the rear end 20. The lobe 28 on each of the curved jaws 14 pivotally engages each other for pivotally retaining the curved jaws 14 together. The clamp 12 includes a pair of levers 30 each extending away from the rear end 20 of a respective one of the curved jaws 14. The pair of levers 30 angles away from each other when the clamp 12 is in the closed position. In this way the levers 30 can be squeezed together by a user to urge the clamp 12 into an open position. The front end 22 of each of the curved jaws 14 is urged away from each other when the levers 30 are squeezed together. In this way the curved jaws 14 can be positioned around the stem 16 of the sprinkler head 18.

Each of the levers 30 has a first surface 32 and the first surface 32 of each of the levers 30 is directed toward each other. The first surface 32 of each of the levers 30 has a well 34 extending inwardly into the first surface 32 and the well 34 extends from the lobe 28 on the respective curved jaw toward a distal end 36 of the levers 30. The bottom surface 26 of each of the curved jaws 14 rests against a top side 38 of a housing 40 of the sprinkler head 18 when the curved jaws 14 are positioned around the stem 16 of the sprinkler head 18. Moreover, a head 42 of the sprinkler head 18 abuts the top surface 24 of each of the curved jaws 14 when the stem 16 retracts into the housing 40. In this way the head 42 is retained in an exposed position for servicing the sprinkler head 18.

A pin 44 extends through the lobe 28 on each of the curved jaws 14 for pivotally coupling the lobe 28 on each of the curved jaws 14 together. A biasing member 46 is integrated into the clamp 12 and the biasing member 46 is positioned around the pin 44. The biasing member 46 including a pair of legs 48 that is each positioned in the well 34 in the first surface 32 of a respective one of the levers 30. Moreover, the legs 48 are biased away from each other thereby facilitating the clamp 12 to be biased into the closed position. The legs 48 are compressible toward each other thereby facilitating the clamp 12 to be urged into the open position.

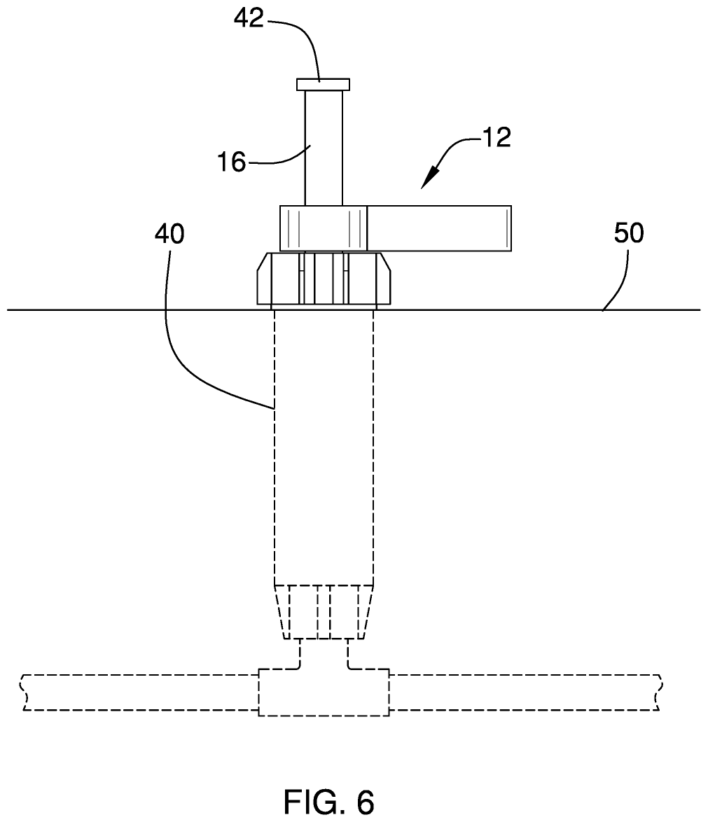

In use, the sprinkler head 18 is turned on and the clamp 12 is positioned around the stem 16 of the sprinkler head 18. In this way the stem 16 is inhibited from retracting in the housing 40 when the sprinkler head 18 is turned off. Thus, the stem 16 and the head 42 remain exposed to facilitate inspection and service to be performed. As is most clearly shown in FIG. 6, having the head 42 exposed with respect to ground 50 during service work facilitates the head 42 to be removed from the stem 16 without fear of dirt falling into the stem 16 and potentially causing a blockage. The clamp 12 is removed from the stem 16 to facilitate normal operation of the sprinkler head 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sprinkler clamp assembly for retaining a sprinkler head in a deployed position during servicing procedures, said assembly comprising:
a clamp having a pair of curved jaws, each of said curved jaws curving toward each other such that said pair of curved jaws defines a circle when said clamp is biased into a closed position thereby facilitating said curved jaws to encircle a stem of a sprinkler head, each of said curved jaws resting against a housing of the sprinkler head when said curved jaws are positioned around the stem of the sprinkler head, a head of the sprinkler head abutting each of said curved jaws when the stem retracts into the housing to retain the head in an exposed position for servicing.

2. The assembly according to claim 1, wherein each of said curved jaws has a rear end and an front end, each of said curved jaws being concavely arcuate between said front end and said rear end, each of said curved jaws having a top surface extending between said front end and said rear end, each of said curved jaws having a bottom surface extending between said front end and said rear end, said front end of each of said curved jaws being spaced apart from each other when said clamp is in said closed position, each of said curved jaws including a lobe extending laterally away from said rear end, said lobe on each of said curved jaws pivotally engaging each other for pivotally retaining said curved jaws together.

3. The assembly according to claim 2, wherein said clamp includes a pair of levers each extending away from said rear end of a respective one of said curved jaws, said pair of levers angling away from each other when said clamp is in said closed position wherein said levers are configured to be squeezed together by a user, said front end of each of said curved jaws being urged away from each other when said levers are squeezed together thereby facilitating said curved jaws to be positioned around the stem of the sprinkler head.

4. The assembly according to claim 3, wherein each of said levers has a first surface, said first surface of each of said levers being directed toward each other, said first surface of each of said levers having a well extending inwardly into said first surface, said well extending from said lobe on said respective curved jaw toward a distal end of said levers.

5. The assembly according to claim 1, wherein:
each of said curved jaws includes a lobe extending laterally away from said rear end, said lobe on each of said curved jaws pivotally engaging each other for pivotally retaining said curved jaws together;
said clamp includes a pair of levers, each of said levers has a first surface, said first surface of each of said levers being directed toward each other, said first surface of each of said levers having a well extending inwardly into said first surface, said well extending from said lobe on said respective curved jaw toward a distal end of said levers;
said assembly includes a pin extending through said lobe on each of said curved jaws for pivotally coupling said lobe on each of said curved jaws together; and
said assembly includes a biasing member being integrated into said clamp, said biasing member being positioned around said pin, said biasing member including a pair of legs, each of said legs being positioned in said well in said first surface of a respective one of said levers, said legs being biased away from each other thereby facilitating said clamp to be biased into said closed position, said legs being compressible toward each other thereby facilitating said clamp to be urged into said open position.

6. A sprinkler clamp assembly for retaining a sprinkler head in a deployed position during servicing procedures, said assembly comprising:
a clamp having a pair of curved jaws, each of said curved jaws curving toward each other such that said pair of curved jaws defines a circle when said clamp is biased into a closed position thereby facilitating said curved jaws to encircle a stem of a sprinkler head, each of said curved jaws having a rear end and an front end, each of said curved jaws being concavely arcuate between said front end and said rear end, each of said curved jaws having a top surface extending between said front end and said rear end, each of said curved jaws having a bottom surface extending between said front end and said rear end, said front end of each of said curved jaws being spaced apart from each other when said clamp is in said closed position, each of said curved jaws including a lobe extending laterally away from said rear end, said lobe on each of said curved jaws pivotally engaging each other for pivotally retaining said curved jaws together, said clamp including a pair of levers each extending away from said rear end of a respective one of said curved jaws, said pair of levers angling away from each other when said clamp is in said closed position wherein said levers are configured to be squeezed together by a user, said front end of each of said curved jaws being urged away from each other when said levers are squeezed together thereby facilitating said curved jaws to be positioned around the stem of the sprinkler head, each of said levers having a first surface, said first surface of each of said levers being directed toward each other, said first surface of each of said levers having a well extending inwardly into said first surface, said well extending from said lobe on said respective curved jaw toward a distal end of said levers, said bottom surface of each of said curved jaws resting against a top side of a housing of the sprinkler head when said curved jaws are positioned around the stem of the sprinkler head, a head of the sprinkler head abutting said top surface of each of said curved jaws when the stem retracts into the housing to retain the head in an exposed position for servicing;
a pin extending through said lobe on each of said curved jaws for pivotally coupling said lobe on each of said curved jaws together; and
a biasing member being integrated into said clamp, said biasing member being positioned around said pin, said biasing member including a pair of legs, each of said legs being positioned in said well in said first surface of a respective one of said levers, said legs being biased away from each other thereby facilitating said clamp to be biased into said closed position, said legs being compressible toward each other thereby facilitating said clamp to be urged into said open position.

7. A sprinkler clamp system for retaining a sprinkler head in a deployed position during servicing procedures, said system comprising:
a sprinkler head having a housing, a stem and a head, said stem being extendable or retractable with respect to said housing;
a clamp having a pair of curved jaws, each of said curved jaws curving toward each other such that said pair of curved jaws defines a circle when said clamp is biased into a closed position thereby facilitating said curved jaws to encircle said stem of said sprinkler head, each of said curved jaws having a rear end and an front end, each of said curved jaws being concavely arcuate between said front end and said rear end, each of said curved jaws having a top surface extending between said front end and said rear end, each of said curved jaws having a bottom surface extending between said front end and said rear end, said front end of each of said curved jaws being spaced apart from each other when said clamp is in said closed position, each of said curved jaws including a lobe extending laterally away from said rear end, said lobe on each of said curved jaws pivotally engaging each other for pivotally retaining said curved jaws together, said clamp including a pair of levers each extending away from said rear end of a respective one of said curved jaws, said pair of levers angling away from each other when said clamp is in said closed position wherein said levers are configured to be squeezed together by a user, said front end of each of said curved jaws being urged away from each other when said levers are squeezed together thereby facilitating said curved jaws to be positioned around said stem of said sprinkler head, each of said levers having a first surface, said first surface of each of said levers being directed toward each other, said first surface of each of said levers having a well extending inwardly into said first surface, said well extending from said lobe on said respective curved jaw toward a distal end of said levers, said bottom surface of each of said curved jaws resting against a top side of said housing of said sprinkler head when said curved jaws are positioned around said stem of said sprinkler head, said head of said sprinkler head abutting said top surface of each of said curved jaws when said stem retracts into said housing to retain said head in an exposed position for servicing;
a pin extending through said lobe on each of said curved jaws for pivotally coupling said lobe on each of said curved jaws together; and
a biasing member being integrated into said clamp, said biasing member being positioned around said pin, said biasing member including a pair of legs, each of said legs being positioned in said well in said first surface of a respective one of said levers, said legs being biased away from each other thereby facilitating said clamp to be biased into said closed position, said legs being compressible toward each other thereby facilitating said clamp to be urged into said open position.
